(19) United States
(12) Patent Application Publication
(10) Pub. No.: US 2004/0184174 A1
(43) Pub. Date: Sep. 23, 2004

(54) Portable data storage device

(76) Inventor: Joong Gu Woo, Gyunggi-do (KR)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 10/626,497

(22) Filed: Jul. 24, 2003

(30) Foreign Application Priority Data
Feb. 18, 2003 (KR) 2003-10188

(51) Int. Cl. G11B 5/09

(52) U.S. Cl. 360/39

(57) ABSTRACT

The present invention discloses a portable data storage device, and more particularly, to a portable data storage device with a very small-sized hard disk, which improves the transportability and user convenience of a data storage device and increase use efficiency by storing data of an information system and allowing a data access if required. The portable data storage device can store a large capacity data by connecting to an information system via a media connector supporting an interface and then storing data of the corresponding information system on a very small-sized hard disk, thereby obtaining transportability. In addition, the portable data storage device provides user convenience by allowing a user to access to the data stored in the data storage device.

### BACKGROUND OF THE INVENTION

1. Field of the Invention

The present invention relates to a portable data storage device, and more particularly, to a portable data storage device with a very small-sized hard disk, which improves the transportability and user convenience of a data storage device and increase use efficiency by storing data of an information system and allowing a data access if required.

2. Description of the Related Art

Recently, with the development of the digital technology, a variety of portable storage devices capable of storing multimedia data are becoming popular. Such devices are being used for, for example, digital camcorders, digital cameras, MP3 players, digital recording machines and so on. In these devices, as a medium for storing data, a memory device or a small-sized hard disk has been mostly utilized. Such a medium has been provided in the form of a detachable card of light, thin, short and small type, such as a multimedia card, SMC, DS, compact flash, memory stick and MD. As a device for storing and backing up data of an information system, there has been used an interface using a USB or a parallel port or serial port, and for a data backup, a PC or notebook and the like has been used.

Data backup is executed by using a data storage device such as an information system hard disk, a magnetic tape or an optical disk. But, these data storage devices had a disadvantage in that they are not portable.

The hard disk, which is a kind of a magnetic disk, is expensive and less transportable, but it provides more storage capability and higher approach velocity. On the other hand, though a magnetic tape is low in approach velocity due to its sequential access method, it is chip and thus mainly used for a data backup.

And, the optical disk such as a CD-ROM(Read Only Memory) has a lower approach velocity than a hard disk due to its direct access method and can store a large quantity of data at a low price, but it has a disadvantage that, if data is once stored, it cannot be removed and restored.

Besides, the data storage devices such as the above-stated hard disk, magnetic tape or optical disk had another problem that it is inconvenient to transport them. Due to this problem, portable storage devices such as a CD-RW (Rewritable) or ZIP drive have been recently developed and used. The CD-RW can write data over and over again but has a decisive disadvantage that it is weak in compatibility, and it cannot be read by a CD-ROM drive or CD recorder yet.

And, the ZIP drive has currently a large storage capacity and the interface for receiving the ZIP drive includes a parallel method for connecting to a printer port and a SCSI method for inserting into a SCSI card. This ZIP drive is superior in stability and compatibility to the CD-RW and thus alleviates the above-mentioned inconveniency of transportation more or less, but it cannot overcome this problem completely.

As described above, the data storage devices, such as the conventional hard disk, magnetic tape and optical disk, was disadvantageous in that it is inconvenient to transport, and the portable storage devices such as the CD-RW or ZIP drive was disadvantageous in that they are poor in compatibility or storage capacity and have a large size and thus cannot overcome the inconveniency of transportation.

Although portable data storage devices using a flash memory have been recently used, they cannot overcome the disadvantages of a low approach velocity, a small capacity and a high price. While the portable storage devices using a hard disk had a difficulty that they should be equipped with a power supply unit because they are fragile and requires too high power consumption.

FIG. 1 is a view of one example of a conventional portable storage device, wherein data is transmitted and backed up to a portable storage device, such as a digital camcorder, digital camera, MP3 player, digital recording machine and so on. Although a digital camera 101 as a portable device and a personal computer 105 as an external information system are exemplified in this drawing, a personal notebook or microcomputer or the like is also applicable.

In FIG. 1, it is known that a memory card 102 mountable on the digital camera 101 is connected to a transmission unit and is connected to the personal computer 105 via a cable 104 and a cable connector 107 as a connecting terminal is inserted and mounted into a parallel port 106 of the computer.

In other words, a compact flash memory card that has been employed up to date in a digital cameral or PDA is very high in price per MB. Thus, in case of purchasing a compact flash memory card of a high capacity, for instance, 64 MB or 128 MB, it costs too much. For this reason, alternate auxiliary storage media have been developed by manufactures, particularly, a click drive of 40 MB which is relatively chip has been developed. However, the click drive has a low level of generality, thus it is disadvantageous in that a dedicated drive or PC card drive must be used and a PDA or digital camera also can be used in a device that can support them.

### SUMMARY OF THE INVENTION

The present invention is designed in consideration of the problems of the prior art, and therefore it is an object of the present invention to provide a portable data storage device, and more particularly, to a portable data storage device with a very small-sized hard disk, which improves the transportability and user convenience of a data storage device and increase use efficiency by storing data of an information system and allowing a data access if required.

It is another object of the present invention to provide a portable data storage device which is operable by a power source supplied from an information system without any particular power source, improve transportability and offer user convenience.

To achieve the above object, there is provided a portable data storage device according to the present invention, comprising: a hard disk unit for mounting a robust hard disk of a very small size and a large capacity and controlling the same; a display unit for notifying a user of a state of the device; an interface unit for interfacing an external device and receiving a power from outside; a control unit for controlling each of the units; and a memory unit equipped with a ROM or RAM for providing a memory required for the control unit.

### BRIEF DESCRIPTION OF THE DRAWINGS

Other objects and aspects of the present invention will become apparent from the following description of embodiments with reference to the accompanying drawing in which:

FIG. 1 is a view of one example of a conventional portable storage device;

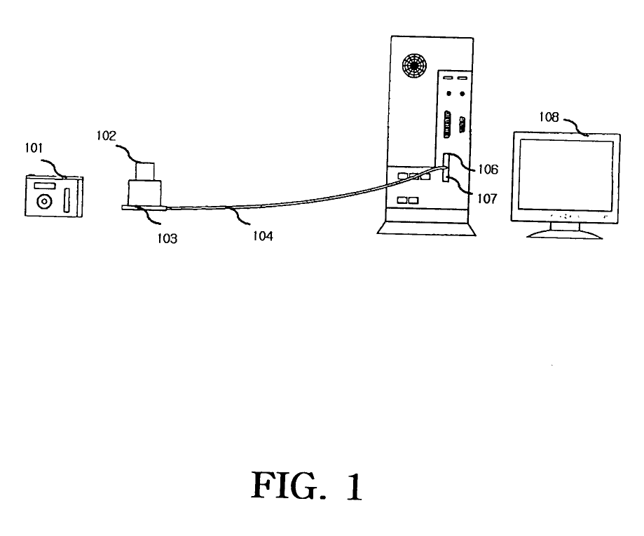

FIG. 2 is a view showing a portable data storage device according to a preferred embodiment of the present invention;

FIG. 3 shows a very small-sized hard disk according to the preferred embodiment of the present invention; and

FIG. 4 is a view of a data storage device employing a USB interface according to the preferred embodiment of the present invention.

### DESCRIPTION OF THE PREFERRED EMBODIMENT

Hereinafter, a preferred embodiment of the present invention will be described in more detail referring to the drawings.

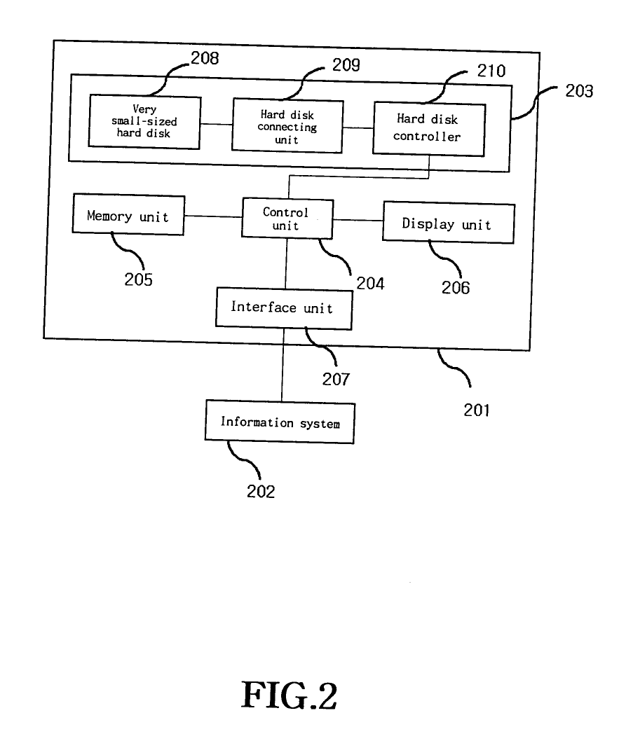

FIG. 2 is a view showing a portable data storage device according to a preferred embodiment of the present invention.

As shown therein, the portable data storage device, which is equipped with a memory, comprises: a hard disk unit 203 for mounting a robust hard disk of a very small size and a large capacity and controlling the same; a memory unit 205 equipped with a ROM or RAM for providing a memory required for a control unit; a display unit 206 for notifying a user of a state of the device; an interface unit 207 for interfacing an external device and receiving a power from outside; and a control unit 204 for controlling each of the units.

The ROM or RAM functions as a memory and stores various programs and data required for the control unit.

The control unit serves to transmit and receive data in a proper protocol.

In the control unit, if needed, a compaction program is operated for storing a larger capacity data in the above-stated hard disk of very small size.

For this purpose, naturally, the compaction program can be previously stored in the ROM.

Preferably, the interface unit can provide a USB interface. Besides, it can provide an IEEE 1394 interface, parallel interface, serial interface, PCMCIA and so on.

Among these interfaces, the USB interface, for example, has a maximum data transfer speed of 480 Mbps, which is much higher than that of the parallel port most commonly used in PCs at the present time. In addition, the USB interface is completely provided with the Plug & Play function, thus peripheral devices can be replaced as required without turning off and on the computer. Moreover, power sources are simultaneously supplied, thus the USB interface can be used without any particular power supply adaptor.

Especially, the USB interface can be connected to a connector supported by a main board without any particular controller similarly with the SCSI interface, and it has 128 connecting devices and thus is superior in extensibility to the parallel port, SCSI and IDE interface.

Accordingly, it is preferable that the USB interface is equipped according to the preferred embodiment of the present invention.

When using the USB interface, it should be plugged or unplugged with a PC power turned on. The USB interface is small-sized and robust, so you can carry it wherever you go and it can be easily installed by its USB method. Further, it is automatically set as a virtual drive in the newest version of Windows without any installation work and without turning on and off the power.

In addition to the recognition of the USB interface as an automatically set Virtual drive, according to another embodiment, the windows system, which is a computing environment of all personal computers, and various office packages or data can be carried, being mounted on the device of this invention. As occasion demands, when the device is mounted to the USB of a personal computer and the option of booting from the USB is selected, the user can be provided with a desired computing environment whenever and wherever.

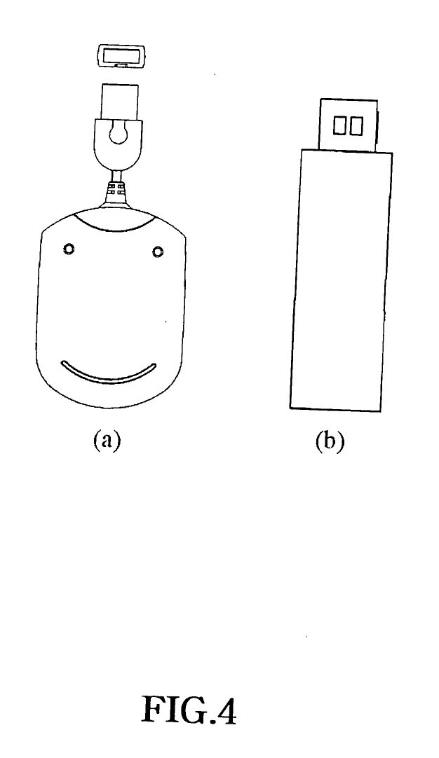

FIG. 4 is a view of a data storage device employing a USB interface according to the preferred embodiment of the present invention.

Both (a) and (b) types are equipped with the USB interface and are of a size capable of being held by the hand and put into a pocket of a Y-shirt when carried, so it is very convenient to carry it.

As shown in FIG. 2, a portable data storage device 201 and a hard disk unit 203 are included. In the hard disk unit, a very small-sized hard disk 208 is mounted.

That is, the hard disk unit 203 includes a very small-sized hard disk 208 which has a size of about 1 square inch, a storage capacity of 1 to 100 GB, a very low power consumption and robustness, a hard disk controller 210 controlling the operation of the hard disk under control of the control unit and a hard disk connecting unit 209 enabling the connection and linking between the hard disk controller 210 and the very small-sized hard disk 208.

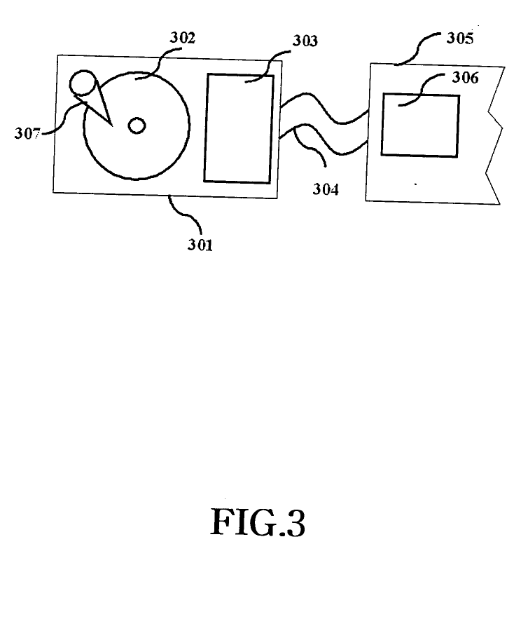

FIG. 3 shows a very small-sized hard disk according to the preferred embodiment of the present invention.

The very small-sized hard disk is of a size of about 1 square inch and has a storage capacity of 1 to several hundreds of GB.

The power consumption of the very small-sized hard disk is low enough to be operated by a power supplied from the USB or IEEE 1394 interface.

In addition, while each of the above devices can bear 2 kilograms, the very small-sized hard disk has a robustness of bearing the weight of more than 2 kilograms. That is, the very small-sized hard disk is 50 times stronger against an impact than a general hard disk.

The very small-sized hard disk 301 of FIG. 3 has inside a hard disk plate 302, a hard disk arm 307, a hard disk dedicated controller 303 for directly controlling the hard disk arm 307 and the hard disk plate 302 and a hard disk connector 304 for connecting the hard disk 301 and a hard disk controller 305. The hard disk connector 304 includes various types, preferably, one with 20 pins. The hard disk connector 304 with 20 pins is good enough to perform various operations such as write, read and test of the hard disk 301 and can supply a power.

The hard disk controller 305 is equipped inside with a hard disk controller IC 306. The hard disk controller IC 306 can be implemented in various ASIC formats, preferably, in a compact flash type II or ATA/ATAPI mode. Thus, it may be a general software or driver that supports a compact flash interface or ATA/ATAPI mode without any particular software, and is compatible with any existing conventional hardware.

Practically, the hard disk unit 203 is overally robust, requires a small power consumption and has a capacity of more than several GB, that is, a capacity capable of storing hundreds to tens of thousands of music pieces in the MP3 format.

The present invention aims at the overall construction of a portable, large capacity data storage device with a very small-sized hard disk, which is portable and convenient to carry without any power source because the hard disk unit is operable by a power source supplied from an interface.

Although the invention has been described with reference to particular embodiments, the description is only an example of the invention's application and should not be taken as a limitation. Various adaptations and combinations of features of the embodiments disclosed are within the scope of the invention as defined by the following claims.

As seen from above, the present invention has overcome one of the disadvantages of a flash memory that the data recording speed of a flash memory chip is lower than that of a disk by using a very small sized hard disk, and its storage cost is much lower than the flash memory.

The present invention provides the effect of being operable only by a power of an external information system without any particular power source by employing a very small-sized hard disk requiring smaller power consumption that existing hard disks.

What is claimed is:

1. A portable data storage device, which is equipped with a memory, comprising:
a hard disk unit for mounting a robust hard disk of a very small size and a large capacity and controlling the same;
a display unit for notifying a user of a state of the device;
an interface unit for interfacing an external device and receiving a power from outside;
a control unit for controlling each of the units; and
a memory unit equipped with a ROM or RAM for providing a memory required for the control unit.

2. The device of claim 1, wherein the hard disk unit includes:
a very small-sized hard disk which has a size of about 1 square inch, a storage capacity of 1 to 100 GB, a very low power consumption and robustness;
a hard disk controller controlling the operation of the hard disk under control of the control unit; and
a hard disk connecting unit enabling the connection and linking between the hard disk controller and the very small-sized hard disk.

3. The device of claim 1, wherein the interface unit is any one of a USB interface, parallel interface, serial interface, PCMCIA interface and IEEE 1394 interface.

4. The method of claim 3, wherein, when connected to a windows system of a personal computer with the interface equipped, the interface is automatically recognized as a virtual drive without turning on and off the power.

5. The device of claim 2, wherein the hard disk controller has inside a hard disk controller IC, the hard controller IC supporting the ATA/ATAPI mode or compact flash type.

6. The device of claim 1, wherein the portable data storage device is of a size capable of being held by the hand and put into a pocket of a Y-shirt when carried.

7. The device of claim 2, wherein the very small-sized hard disk includes:
a hard disk plate and a hard disk arm;
a hard disk dedicated controller for directly controlling the hard disk arm and the hard disk plate; and
a hard disk connector for connecting the hard disk and the hard disk controller,
wherein the hard disk connector is a connector with 20 pins.

8. The device of claim 3, wherein, when the device is equipped with the USB or IEEE 1394 interface and a personal computer is booted in the USB or IEEE 1394 interface, the computing environment of the user is implemented as its.
